(19) United States
(12) Patent Application Publication
(10) Pub. No.: US 2007/0061848 A1
(43) Pub. Date: Mar. 15, 2007

(54) Bluetooth system with enhanced data receiving capability

(75) Inventor: Myung-hak Kang, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/386,691

(22) Filed: Mar. 23, 2006

(30) Foreign Application Priority Data
Sep. 12, 2005 (KR) 2005-0084753

(51) Int. Cl. H04N 7/18

(52) U.S. Cl. 725/81; 725/80; 725/78

(57) ABSTRACT

A Bluetooth system includes a set-top box transmitting/receiving data to/from a communication terminal, and a Bluetooth module installed on the outside of the set-top box and connected to the set-top box through a first cable, and converting the data into a predetermined format. The Bluetooth module is installed at a position to meet an optimal data receiving condition. The set-top box includes a first connection unit to which the first cable is connected. A failure in the data communication of the set-top box caused by the limitation in the installation location and area, such as walls or other blocking structure surrounding the set-top box, can be addressed.

### CROSS-REFERENCE TO RELATED APPLICATIONS

This application claims benefit under 35 U.S.C. § 119 from Korean Patent Application No. 2005-84753 filed on Sep. 12, 2005 in the Korean Intellectual Property Office, the entire content of which is hereby incorporated by reference.

### BACKGROUND OF THE INVENTION

1. Field of the Invention

The present invention relates in general to a Bluetooth system. More specifically, the present invention relates to a Bluetooth system with an improved set-top box structure featuring an enhanced data receiving capability.

2. Description of the Related Art

Bluetooth is a wireless protocol or a product conforming to the protocol for real-time bidirectional communication that uses radio links between computers and their connected units such as mobile terminals or home appliances.

FIG. 1 is a schematic block diagram of a Bluetooth set-top box according to a related art.

The related art set-top box 10 includes a Universal Asynchronous Receiver and Transmitter (UART) interface unit 13, a Bluetooth module 15, and an antenna 17.

The UART interface unit 13 is built in the set-top box 10, which typically handles asynchronous serial communications at 115 kbps. The Bluetooth module 15 is a device for making data to be transmitted/received to/from a terminal through the set-top box 15 in a common format. The antenna 17 makes it possible to transmit and receive data between the set-top box and the terminal.

FIG. 2 is a diagram illustrating an interactive service using the Bluetooth set-top box 10 of the related art.

Operational principle of the Bluetooth set-top box 10 is explained as follows with reference to FIGS. 1 and 2, where an existing digital TV signal and interactive data from a satellite 20 are received through an antenna 17 installed in the set-top box 10. The data are inputted to a CPU with a built-in MPEG2 decoder in the MPEG2 format.

An input signal to the CPU is received at a Digital Storage Media-Command and Control (DSM-CC) data receiving rate of 6 Mbps or higher.

To realize a Bluetooth application software stored in a flash memory of the set-top box 10, a specific program to meet such need is installed in a predetermined area of the SDRAM. Thus, when a signal is inputted, an adequate process is executed accordingly. Thusly processed interactive data are converted using Bluetooth protocol while passing through the UART interface unit 13, and transmitted to a terminal 30.

An application program provided to the terminal 30 is usually upgraded by a related terminal manufacturer. The Bluetooth data received at the terminal are therefore processed in the terminal and displayed to a user.

An application command the user selects is transferred from the terminal 30 to a service provider 40 through a return channel. Then, a content provider 50 processes the command into an interactive data and transmits it to the satellite 20 through a satellite antenna 60. In this way, the satellite 20 or Head END producers are able to provide Bluetooth data.

However, since the related art set-top box 10 is mainly utilized as a Bluetooth data transmission/receiving device, it is faced with a problem due to the limitation in the installation location and area. In effect, the set-top box 10 sometimes fails to receive data because of the walls or other blocking structure surrounding the set-top box 10.

### SUMMARY OF THE INVENTION

It is, therefore, an object of the present invention to provide a Bluetooth system with an improved set-top box structure featuring an enhanced data receiving capability

To achieve the above and other exemplary objects and advantages, exemplary embodiments of the present invention provided a Bluetooth system comprising a set-top box transmitting/receiving data to/from a communication terminal, and a Bluetooth module installed on the outside of the set-top box and connected to the set-top box through a first cable, and converting the data into a predetermined format.

According to an exemplary embodiment of the present invention, the Bluetooth module is installed at a position to optimize a data receiving capability of the set-top box.

In an exemplary embodiment of the present invention, the set-top box comprises a first connection unit to which the first cable is connected.

In an exemplary embodiment of the present invention, the first connection unit comprises a ‘DIN 9 Jack’ using ‘RS232C’.

In an exemplary embodiment of the present invention, the first cable comprises an RCA cable.

According to an exemplary embodiment of the present invention, the Bluetooth system may further include a monitor unit connected to the set-top box through a second cable.

In an exemplary embodiment of the present invention, the set-top box includes a second connection unit to which the second cable is connected.

In an exemplary embodiment of the present invention, the second connection unit comprises a ‘DIN 9 Jack’ using ‘RS232C’.

In an exemplary embodiment of the present invention, the set-top box comprises a satellite STB.

### BRIEF DESCRIPTION OF THE DRAWINGS

The above aspects and features of the present invention will be more apparent by describing certain embodiments of the present invention with reference to the accompanying drawings, in which like reference numerals will be understood to refer to like parts, components and structures, where:

FIG. 1 is a schematic block diagram of a Bluetooth set-top box according to a related art;

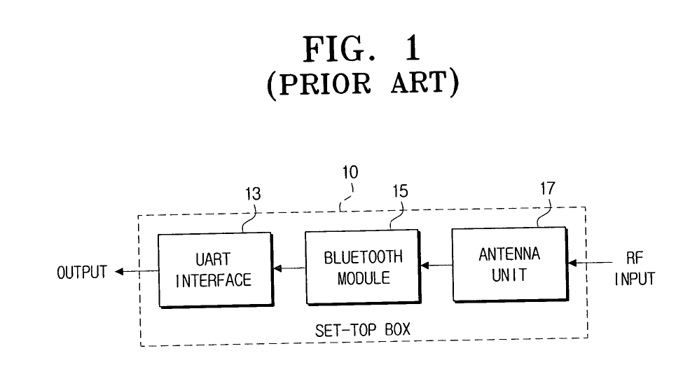

FIG. 2 is a diagram illustrating an interactive service using the Bluetooth set-top box of the related art; and

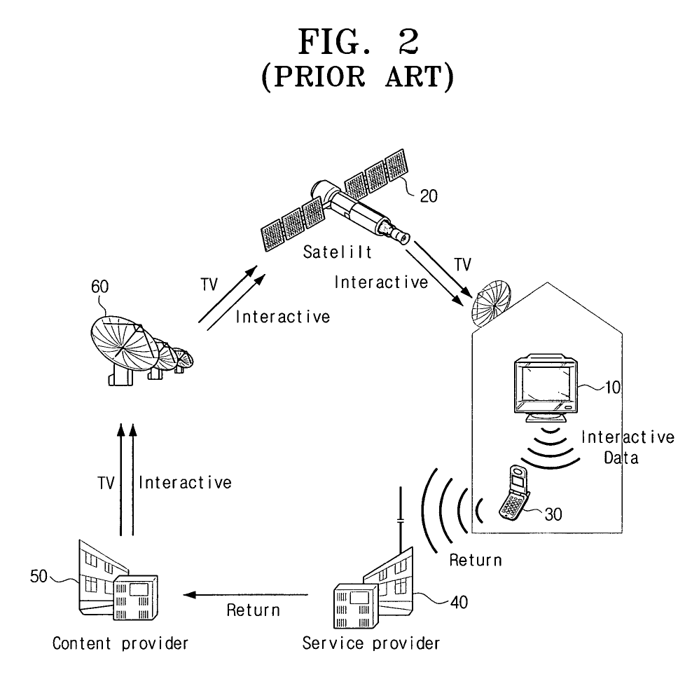

FIG. 3 is a schematic block diagram of a Bluetooth system according to an exemplary embodiment of the present invention.

### DETAILED DESCRIPTION OF EXEMPLARY EMBODIMENTS

Exemplary embodiments of the present invention will be described herein below with reference to the accompanying drawings.

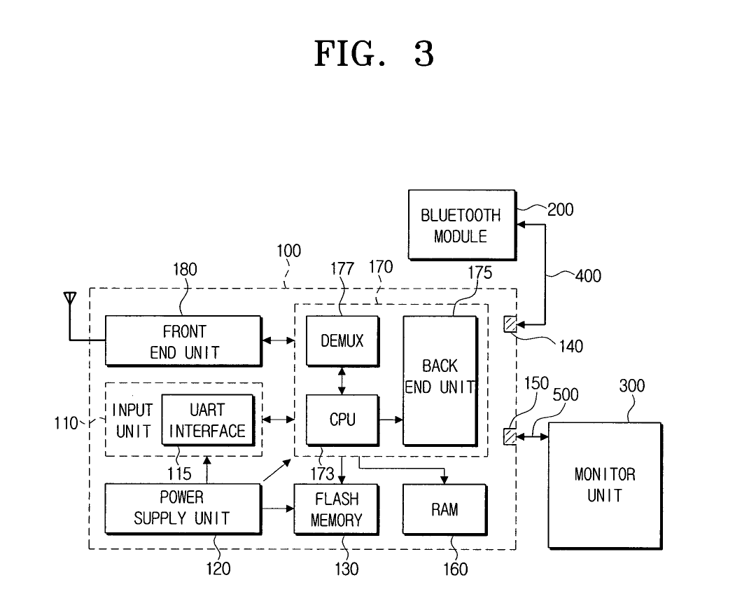

FIG. 3 is a schematic block diagram of a Bluetooth system according to an exemplary embodiment of the present invention.

Referring to FIG. 3, the Bluetooth system includes a set-top box 100, a Bluetooth module 200, a monitor unit 300, a first cable 400 and a second cable 500.

The Bluetooth module 200 is not built in the set-top box 100. Instead, the set-top box 100 communicates with the Bluetooth module 200 through the first cable 400. Similarly, the set-top box 100 communicates with the monitor unit 300 through the second cable 500. Apart from this, the signal flow in the set-top box 100 can be configured analogously to a signal flow in a conventional set-top box.

In an exemplary implementation of the present invention, a satellite set-top box (STB) can be used as the set-top box 100 as shown in FIG. 3. The satellite STB is a device that receives MPEG2 digital data via a satellite, converts the data into an MPEG2 signal through a built-in QPSK (this is a satellite receiver specialized in catching satellite signals), and decodes the signal to a general A/V signal for viewers.

The set-top box 100 includes an input unit 110, a power supply unit 120, a flash memory 130, a RAM 160, a main chip 170, and a front end unit 180. The main chip 170 includes a CPU 173, a back end unit 175, and a demultiplexing unit 177. The input unit 110 includes a UART interface 115.

The input unit 110 controls channel selection in response to a user input and transfers a user command such as an operation mode to the main chip 170.

The flash memory 130 stores a boot loader, the program required for initiating the set-top box 100, and a code of an application program controlling overall operations of the set-top box 100.

The main chip 170 is initialized by executing the boot loader stored in the flash memory 130. Once initialized, the main chip 170 executes the code of an application program so that the application program may run. Moreover, the main chip 170 decodes a digital broadcasting signal inputted from the front end unit 180 according to the application program, and outputs the decoded signal to the outside.

In an exemplary implementation, the CPU 173 of the main chip 170 is booted by the boot loader, and the boot loader makes the CPU 173 execute the application program. As such, the CPU 173 receives the code of the application program from the flash memory 130, and loads it on the RAM 160 for execution of the code.

Once the application program starts running, the demultiplexing unit 177 separates the digital broadcasting signal received from the front end unit 180 into a video signal and an audio signal. And the back end unit 175 decompresses the audio and video signals from the demultiplexing unit 177, and outputs them to the outside.

The front end unit 180 executes MPEG decoding provided that the set-top box 100 receives Bluetooth data via a satellite, other cables, ground waves, or other means.

The CPU 173 decodes MPEG signals received from the front end unit 180, and classifies the signals according to information. For instance, according to information, A/V signals are output as analog signals through a video decoder, and part of Bluetooth data are transmitted to the UART interface 115 after going through a separate treatment.

The Bluetooth module 200 is a device for making data to be transmitted/received to/from a terminal through the set-top box 100 in a common format. As aforementioned, the Bluetooth module 200 is not built in the set-top box 100, but installed outside the set-top box 100 separately. The Bluetooth module 200 is connected to the set-top box 100 through the first cable 400.

The monitor unit 300 is a PC which is used for downloading a program onto the set-top box 100 by doing data communication with Hyperterminal, receiving an internal message to examine the problems, if any, of the set-top box 100, or executing a function using short-cut keys, and is connected to the set-top box 100 through the second cable 500.

The second cable 500 supports data communication between the set-top box 100 and the monitor unit 300. In general, it consists of three signals (Txd, Rxd, and Ground). According to an exemplary implementation the present invention, an external modem may be added by an additional signal line.

On the other hand, the first cable 400 supports communication between the set-top box 100 and the Bluetooth module 200. The first cable 400 can be specially designed to take full advantages of the Bluetooth module 200. In an exemplary implementation, an ‘RCA’ cable may be used as the first cable 400 for certain embodiments of the present invention.

The first cable 400 and the second cable 500 are connected to a first connection unit 140 and a second connection unit 150, respectively, of the set-top box 100.

As for the first connection unit 140 and the second connection unit 150, a ‘DIN 9 Jack’ using the RS232C jack can be used. In an exemplary implementation, ‘DIN 9 Jack’ comprises a 9 Pin DIN jack, and ‘RS232C’ comprises an interface (or protocol) for data communication.

Since the first connection unit 140 and the second connection unit 150 are different in their functions, they should be treated separately. According to an exemplary implementation, the first connection unit 140 uses different pins from the second connection unit 150.

In an exemplary implementation, the second connection unit 150 uses only 3 pins, Txd, Rxd, and Ground, out of 9 pins, whereas the first connection unit 140 has a specific pin structure for RS232C as shown in Table 1 below.

Table 1 explains the RS232C Port configuration at the first connection unit 140, according to an exemplary embodiment of the present invention.

TABLE 1

| PIN No. | Description | Direction | Explanation |
|---|---|---|---|
| 1 | Power supply | O | Power supply |
| | | | (2.5 VDC˜3.3 VDC) |
| 2 | Blue_Tx | O | Bluetooth |
| | | | transmission data |
| 3 | Blue_Rx | I | Bluetooth receiving |
| | | | data |
| 4 | GND | G | Ground |
| 5 | Blue_RTX | O | Request to Send |
| 6 | Blue_CTS | I | Clear to Send |
| 7 | Blue_Reset | O | Bluetooth chip Reset |
| 8 | Blue_Wake | I | Bluetooth chip wake |
| | | | up signal |
| 9 | Host_Wake | O | Main CPU wake up |
| | | | signal |

Therefore, by using the RS232C Port that is generally provided to the set-top box, it becomes possible to change the position of the Bluetooth module from the inside of the set-top box to the outside of the set-top box. In other words, certain embodiments of the present invention may give more freedom in selecting the position of the Bluetooth module 200.

In consequence, the data receiving capability characterizing the radio frequency of the Bluetooth system can be improved.

As explained so far, according to certain exemplary embodiments of the present invention, some disadvantages of related art set-top box due to the limitation in the installation location and area can be overcome. Accordingly, a failure in the data communication of a set-top box caused by walls or other blocking structure surrounding the set-top box can be addressed.

Although certain exemplary embodiment of the present invention have been described, it will be understood by those skilled in the art that the present invention is not limited to the described exemplary embodiment, but various changes and modifications can be made within the spirit and scope of the present invention as defined by the appended claims and their equivalents.

What is claimed is:

1. A Bluetooth system, comprising:
a set-top box for transmitting/receiving data to/from a communication terminal; and
a Bluetooth module for formatting the data, the Bluetooth module being configured on the outside of the set-top box and connected to the set-top box through a first cable.

2. The Bluetooth system of claim 1, wherein the configuration of the Bluetooth module comprises a position optimizing a data receiving capability of the set-top box.

3. The Bluetooth system of claim 1, wherein the set-top box comprises a first connection unit to which the first cable is connected.

4. The Bluetooth system of claim 3, wherein the first connection unit comprises a DIN 9 Jack using RS232C.

5. The Bluetooth system of claim 1, wherein the first cable comprises an RCA cable.

6. The Bluetooth system of claim 1 further comprising a monitor unit connected to the set-top box through a second cable.

7. The Bluetooth system of claim 6, wherein the set-top box comprises a second connection unit to which the second cable is connected.

8. The Bluetooth system of claim 7, wherein the second connection unit comprises a DIN 9 Jack using RS232C.

9. The Bluetooth system of claim 1, wherein the set-top box comprises a satellite set-top box (STB).
